(19) United States
(12) Patent Application Publication
(10) Pub. No.: US 2016/0321538 A1
(43) Pub. Date: Nov. 3, 2016

(54) Pattern Recognition System and Method

(71) Applicants: MIG AG, München (DE); ZINTERA CORPORATION, La Jolla, CA (US)

(72) Inventor: Hans Geiger, Wessobrunn (DE)

(21) Appl. No.: 15/102,260

(22) PCT Filed: Dec. 8, 2014
(86) PCT No.: PCT/EP2014/076923

§ 371 Date: Jun. 6, 2016

Related U.S. Application Data
(60) Provisional application No. 61/912,779, filed on Dec. 6, 2013.

(51) Int. Cl. G06N 3/06; G06N 3/08; G06N 3/04

(52) U.S. Cl. CPC G06N 3/061; G06N 3/0472; G06N 3/08

(57) ABSTRACT

A pattern recognition system having a plurality of sensors, a plurality of first activation cells wherein ones of the first activation cells are connected to one or more of the sensors, a plurality of second activation cells, wherein overlapping subsets of the first activation cells are connected to ones of the second activation cells, and an output for summing at least outputs from a subset of the plurality of second activation cells to produce a result.

### BACKGROUND OF THE INVENTION

1. Field of the Invention

The invention relates to a method and apparatus for the recognition of a pattern, for example a visual pattern. One application of the invention is for dermatological applications.

2. Description of the Related Art

Artificial neural networks (ANN) are computational models and are inspired by animal central nervous systems, in particular the brain, that are capable of machine learning and pattern recognition. The ANNs are usually presented as a system of nodes or “neurons” connected by “synapses” that can compute values from inputs, by feeding information from the inputs through the ANN. The synapses are the mechanism by which one of the neurons passes a signal to another one of the neurons.

One example of an ANN is for the recognition of handwriting. A set of input neurons may be activated by pixels in a camera of an input image representing a letter or a digit. The activations of these input neurons are then passed on, weighted and transformed by some function determined by a designer of the ANN to other neurons, etc. until finally an output neuron is activated that determines which character (letter or digit) was imaged. ANNs have been used to solve a wide variety of tasks that are hard to solve using ordinary rule-based programming, including computer vision and speech recognition.

There is no single formal definition of an ANN. Commonly a class of statistical models will be termed “neural” if the class consists of sets of adaptive weights (numerical parameters that are tuned by a learning algorithm) and are capable of approximating non-linear functions of the inputs of the statistical models. The adaptive weights can be thought of as the strength of the connections (synapses) between the neurons.

The ANNs have to be trained in order to produce understandable results. There are three major learning paradigms: supervised learning, unsupervised learning and reinforcement learning.

In a supervised learning, the learning paradigms all have in common that a set of pre-analyzed data, for example a set of images, is analyzed by the ANN and the weights of the connections (synapses) between the neurons in the ANN are adapted such that the output of the ANN is correlated with the known image. There is a cost involved in this training. An improvement in the efficiency of the results of the ANN can be obtained by using a greater number of data items in a training set. The greater number of items requires, however, an increase in computational power and time for the analysis in order to get the correct results. There is therefore a trade of trade-off that needs to be established between the time taken to train the ANN and the accuracy of the results.

Recent developments in ANNs involve so-called ‘deep learning’. Deep-learning is a set of algorithms that attempt to use layered models of inputs. Jeffrey Heaton, University of Toronto, has discussed deep learning in a review article entitled ‘Learning Multiple Layers of Representation’ published in Trends in Cognitive Sciences, vol. 11, No. 10, pages 428 to 434, 2007. This publication describes multi-layer neural networks that contain top-down connections and training of the multilayer neural networks one layer at a time to generate sensory data, rather than merely classifying the data.

Neuron activity in prior art ANNs is computed for a series of discrete time steps and not by using a continuous parameter. The activity level of the neuron is usually defined by a so-called “activity value”, which is set to be either 0 or 1, and which describes an ‘action potential’ at a time step t. The connections between the neurons, i.e. the synapses, are weighted with a weighting coefficient, which is usually chosen have a value in the interval [−1.0, +1.0]. Negative values of the weighting coefficient represent “inhibitory synapses” and positive values of the weighting coefficient indicate “excitatory values”. The computation of the activity value in ANNs uses a simple linear summation model in which weighted ones of some or all of the active inputs received on the synapses at a neuron are compared with a (fixed) threshold value of the neuron. If the summation results in a value that is greater than the threshold value, the following neuron is activated.

One example of a learning system is described in international patent application No. WO 199 8027 511 (Geiger), which teaches a method of detecting image characteristics, irrespective of size or position. The method involves using several signal-generating devices, whose outputs represent image information in the form of characteristics evaluated using non-linear combination functions.

International patent application No. WO 2003 017252 relates to a method for recognizing a phonetic sound sequence or character sequence. The phonetic sound sequence or character sequence is initially fed to the neural network and a sequence of characteristics is formed from the phonetic sequence or the character sequence by taking into consideration stored phonetic and/or lexical information, which is based on a character string sequence. The device recognizes the phonetic and the character sequences by using a large knowledge store having been previously programmed.

An article by Hans Geiger and Thomas Waschulzak entitled ‘Theorie and Anwendung strukturierte konnektionistische Systeme’, published in Informatik-Fachreichte, Springer-Verlag, 1990, pages 143-152 also describes an implementation of a neural network. The neurons in the ANN of this article have activity values between zero and 255. The activity values of each one of the neurons changes with time such that, even if the inputs to the neuron remain unchanged. The output activity value of the neuron would change over time. This article teaches the concept that the activity value of any one of the nodes is dependent at least partly on the results of earlier activities. The article also includes brief details of the ways in which system may be developed.

### SUMMARY OF THE INVENTION

The principal of the method and apparatus of recognition of the pattern as described in this disclosure is based upon a so-called biologically-inspired neural network (BNN). The activity of any one of the neurons in the BNN is simulated as a bio-physical process.

The basic neural property of the neuron is a “membrane voltage”, which in (wet) biology is influenced by ion channels in the membrane. The action potential of the neuron is generated dependent on this membrane voltage, but also includes a stochastic (random) component, in which only the probability of the action potential is computed. The action potential itself is generated in a random manner. The membrane has in biology some additional electro-chemical property affects, such as absolute and relative refractory periods, adaptation and sensitization, that are automatically included in the BNN of this disclosure.

The basic information transferred from one of the neurons to another one of the neurons is not merely the action potential (or firing rate, as will be described later), but also a time dependent pattern of the action potentials. This time-dependent pattern of action potentials is described as a single spike model (SSM). This means that the interaction between an input from any two of the neurons is more complex than a simple linear summation of the activities.

The connections between the neurons (synapses) may have different types. The synapses are not nearly just excitatory or inhabitatory (as is the case with an ANN), but may have other properties. For example, the topology of a dendritic tree connecting the individual neurons can also be taken into account. The relative location of the synapses from the two of the input neurons on a dendrite in the dendritic tree may also have a large influence on the direction between the two neurons.

The method and apparatus of this disclosure can be used in the determination of dermatological disorders and skin conditions.

### DESCRIPTION OF THE FIGURES

FIG. 1 shows an example of the system of the disclosure.

### DETAILED DESCRIPTION OF THE INVENTION

The invention is described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

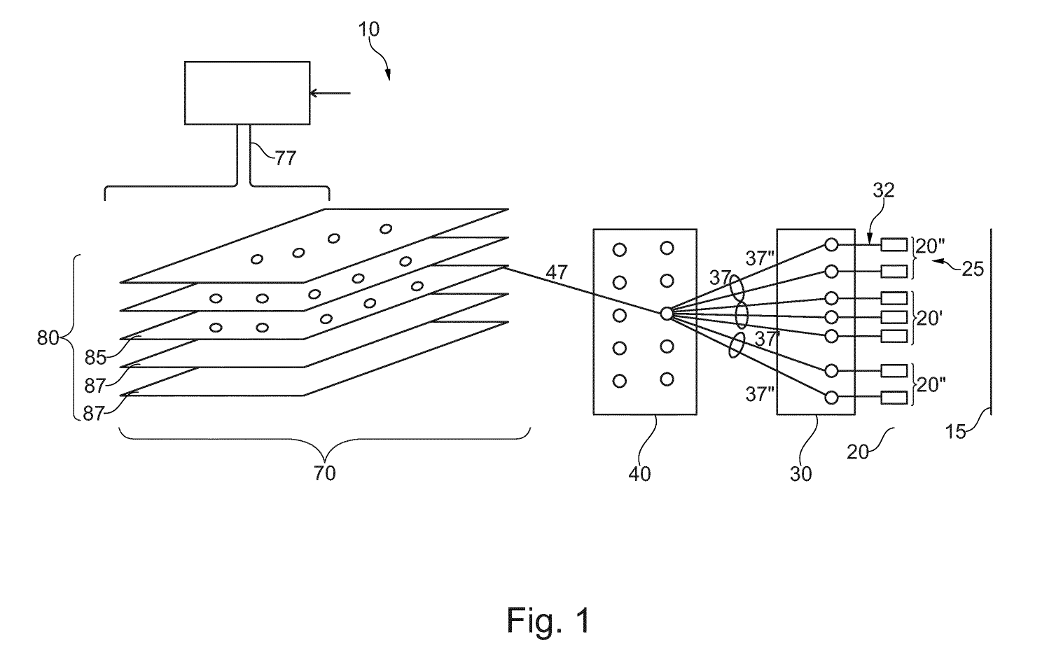

FIG. 1 shows a first example of a pattern recognition system 10 of the invention. The pattern recognition 10 has a plurality of sensors 20, which have sensor inputs 25 receiving signals from a pattern 15. The pattern 15 can be a visual pattern or an audio pattern. The sensor inputs 25 can therefore be light waves or audio waves and the plurality of sensors 20 can be audio sensors, for example microphones, or visual sensors, for example video or still cameras.

The sensors 20 produce a sensor output, which acts as a first input 32 to a plurality of first activation cells 30. The first activation cells 30 are connected in a one-to-one relationship with the sensors 20 or a one-to-many relationship with the sensors 20. In other words, ones of the first activation cells 30 are connected to one or more of the sensors 20. The number of connections depends on the number of sensors 20, for example the number of pixels in the camera, and the number of the first activation cells 30. In one aspect of the invention, there are four pixels from a video camera, forming the sensor 20, and the four pixels are commonly connected to one of the first activation cells 30.

The first activation cells 30 have a first output 37, which comprises a plurality of spikes emitted at an output frequency. In “rest mode”, i.e. with no sensor signal from the sensor 20 on a first input 32, the first activation cells 30 produce the plurality of spikes at an exemplary output frequency of 200 Hz. The first activation cells 30 are therefore an example of a single spike model. The application of the sensor signal on the first input 32 increases the output frequency depending on the strength of the sensor signal from the sensor 20, and is for example up to 400 Hz. The change in the output frequency is substantially immediately on the application and removal of the sensor signal at the first input 32, in one aspect of the invention. Thus the first activation cells 30 react to changes in the pattern 15 almost immediately.

The plurality of first activation cells 30 are connected in a many-to-many relationship with a plurality of second activation cells 40. For simplicity only the connection between one of the second activation cells 40 and an exemplary number of the first activation cells 30 is shown in FIG. 1. The first outputs 37 from the connected ones of the first activation cells are summed over a time period at the connected second activations cell 40.

The values of the outputs 37 are also combined such that the outputs 37′ from (in this case) the three central first activation cells 30 are added, whilst the outputs 37″ from the outer ones of the first activation cells 30 are subtracted from the total output 37. In other words the central three sensors 20′ contribute positively to the signal received at an input 42 of the second activation cell 40, whilst the signal from the outer sensors 20″ are subtracted. The effect of this addition/subtraction is that a pattern 15 comprising a single, unvarying visible shape and colour will, for example, activate at least some of the first activation cells 30 but not activate the second activation cells 40, because the output signals 37 from the first activation cells 30 will cancel each other. It will be appreciated that the aspect of three central first activation cells 30 and the outer ones of the first activation cells 30 is merely an example. A larger number of first activation cells 30 can be used.

The outputs 37′ and 37″ are merely one example of the manner in which the outputs 37 can be combined in general. It was explained in the introduction to the description, that the connections (synapses) between the neurons or activation cells are not generally combined in a linear summation model, but have a stochastic component. This stochastic aspect of the invention in which first activation cells 30 connected to the sensors 20 and to the second activation cells 40 is merely one aspect of the invention. The connections can be modified as appropriate for the use case of the invention.

The second activation cells 40 have different activation levels and response times. The second activation cells 40 also produce spikes at a frequency and the frequency increases dependent on the frequency of the spikes at input signal 42. There is no one-to-one relationship between the output frequency of the second activation cells 40 and the input frequency of the input signal 42. Generally the output frequency will increase with an increase of the input signal 42 and saturates at a threshold value. The dependency varies from one second activation cell 40 to another one of the second activation cells 40 and has a stochastic or random component. The response time of the second activation cells 40 also varies. Some of the second activation cells 40 react almost immediately to a change in the input signal 42, whereas other ones require several time periods before the second activation cells 40 react. Some of the second activation cells 40 are turned to rest and issue no second output signal 47 with increased spike frequency when the input signal 42 is removed, whereas other ones remain activated even if the input signal 42 is removed. The duration of the activation of the second activation cell 40 thus varies across the plurality of activation cells 40. The second activation cells 40 also have a ‘memory’ in which their activation potential depends on previous values of the activation potential. The previous values of the activation potential are further weighted by a decay-factor, so that more recent activations of the second activation cell 40 affects the activation potential more strongly than all the ones.

The second outputs 47 are passed to a plurality of third activation cells 70 arranged in a plurality of layers 80. Each of the plurality of layers 80 comprise a middle layer 85, which is connected to the second outputs 47 and one or more further layers 87, which are connected to third activation cells 70 in other ones of the layers 87. In the example of figure one only five layers 80 are shown, but this is merely illustrative. In one aspect of the invention for the recognition of a visual pattern 15, seven layers are present. It would be equally possible to have a larger number of layers 80, but this would increase the amount of computing power required.

The second outputs 47 are connected in a many-to-many relationship with the second activation cells 40.

The third activations cells 70 also have different activation levels and different activation times as discussed with respect to the second activation cells 40. The function of the second activation cells 40 is to identify features in the pattern 15 identified by the sensor 20, whereas the function of the third activation cells 70 is to classify the combination of the features.

The third activation cells 70 in one of the layers 80 are connected in a many-to-many relationship with third activation cells 70 in another one of the layers 80. The connections between the third activation cells 70 in the different layers 80 are so arranged that some of the connections are positive and reinforce each other, whilst other ones of the connections are negative and diminish each other. The third activation cells 70 also have a spike output, the frequency of which is dependent on the value of their input.

There is also a feedback loop between the output of the third activation cells 70 and the second activation cells 40, which serves as a self-controlling mechanism. The feedback between the third activation cells 70 and the second activation cells is essentially used to discriminate between different features in the pattern 15 and to reduce overlapping information. This is done by using the feedback mechanism to initially strengthen the second activation cells 40 relating to a particular feature in the pattern 15 to allow that feature to be correctly processed and identified. The feedback then reduces the output of the second activation cells 40 for the identified feature and strengthens the value of the second activation cells related to a further feature. This further feature can then be identified. This feedback is necessary in order to resolve any overlapping features in the pattern 15, which would otherwise result in an incorrect classification.

The pattern recognition system 10 further includes an input device 90 that is used to input information items 95 relating to the pattern 15. The information items may include a name or a label generally attached to the pattern 15 and/or to one or more features in the pattern 15. The input device 90 is connected to a processor 100 which also accept the third outputs 77. The processor compares the third outputs 77 relating to a particular displayed pattern 15 with the inputted information items 95 and can associate the particular displayed pattern 15 with the inputted information items. This association is memorized so that if an unknown pattern 15 is detected by the sensors 20 and the third outputs 77 are substantially similar to the association, the processor 100 can determine that unknown pattern 15 is in fact a known pattern 15 and output the associated item of information 95.

The pattern recognition system 10 can be trained to recognize a large number of patterns 15 using an unsupervised leaning process. These patterns 15 will produce different ones of the third outputs 77 and the associations between the information items 95 and the patterns 15 are stored.

### EXAMPLE 1

### Visual Pattern Recognition

The system and method of the current disclosure can be used to determine and classify visual patterns 15.

In this example of the system and method, the sensors 20 are formed from still cameras. The sensors 20 react to colours and intensity of the light. The sensors 20 calculate three values. The first value depends on the brightness, whereas the second and third values are calculated from colour differences (red-green and blue-green). The colour difference values are distributed around 50%. The triggering of the first activation cells 30 depends on a combination of the colour difference and the brightness. The sensors 20 and the first activation cells 30 can be considered to be equivalent to the human retina.

The first outputs 37 from the first activation cells 30 are transferred to the second activation cells 40 and then to the third activation cells 70. The second activation cells 40 can be equated with the human lateral geniculate nucleus (LGN) and the activation cells 70 can be equated with the human cortex. The activation potential of the first activation cells 30 depends upon the original pattern 15. These signals are transferred into the lower levels and initially an apparently random sequence of third activation cells 80 appears to be fired.

The firing stabilises after a certain period of time and “structures” are created within the plurality of layers 80, which reflect the pattern 15 being imaged by the sensors 20.

A label can be associated with the pattern 15. The structure within the plurality of layers 80 corresponds therefore to the pattern 15. The label will be input by the input device 90, such as a keyboard

The procedure is repeated for a different pattern 15. This different pattern 15 created a different structure within the plurality of layers 80. The learning procedure can then proceed using different ones of the patterns 15.

Once the learning is complete, an unknown pattern 15 can be placed in front of the sensors 20. This unknown pattern 15 generates signals in the first activation cells 30 which are transferred to the second activation cells 40 to identify features in the unknown pattern 15 and then into the plurality of layers 80 to enable classification of the pattern 15. The signals in the plurality of layers 80 can be analysed and the structure within the plurality of layers 80 most corresponding to the unknown pattern 15 is identified. The system 10 can therefore output the label associated with the structure. The unknown pattern 15 is therefore identified.

Should the system 10 be unable to identify the unknown pattern 15, because a new type of structure has been created in the plurality of layers 80, then the system 10 can give an appropriate warning and human intervention can be initiated in order to classify the unknown pattern 15 or to resolve in the other conflicts. A user can then manually review the unknown pattern 15 and classify the unknown pattern by associating a label with the unknown pattern or reject the unknown pattern.

The feedback between the second activation cells 40 and the third activation cells 70 can be easily understood by considering two overlapping lines in the visual pattern 15. Initially the first activation cells 30 will register the difference in the visual pattern 15 around the two overlapping lines, but cannot discriminate the type of feature, i.e. separate out the two different lines in the overlapping lines. Similarly adjacent ones of the second activation cells 40 will be activated because of the overlapping nature of the two overlapping lines. If all of the second activation cells 40 and the third activation cells 70 reacted identically, then it would be impossible to discriminate between the two overlapping lines. It was explained above, however, that there is a random or stochastic element to the activation of the second activation cells 40 and to the third activation cells 70. This stochastic element results in some of the second activation cells 40 and/or the third activation cells 70 to be activated earlier than other ones. The mutual interference between the second activation cells 40 or the third activation cells 70 will strengthen and/or weaken the activation potential and thus those second activation cells 40 or third activation cells 70 reacting to one of the overlapping lines will initially mutually strengthen themselves to allow the feature to be identified. The decay of the activation potential means that after a short time (milliseconds) those second activation cells 40 or third activation cells 70 associated with the identified overlapping line diminish in strength and the other second activation cells 40 or other third activation cells 70 relating to the as yet unidentified overlapping line are activated to allow this one of the overlapping lines to be identified.

### EXAMPLE 2

### Identification of Skin Conditions

The system of example 1 can be used to identify different types of skin (dermato-logical) conditions. In this example, the system 10 is trained using a series of patterns 15 in the form of stored black and white or colour digital images of different types of skin conditions with associated labels. In a first step, the digital images are processed using conventional image processing methods so that the remaining image is only focussed on the area of an abnormal skin condition. A qualified doctor associates the image with a label indicating the abnormal skin condition and the system is trained as described above.

1. A pattern recognition system comprising:
a plurality of sensors;
a plurality of first activation cells wherein ones of the first activation cells are connected to one or more of the sensors;
a plurality of second activation cells, wherein overlapping subsets of the first activation cells are connected to ones of the second activation cells; and
an output for summing at least outputs from a subset of the plurality of second activation cells to produce a result.

2. The pattern recognition system of claim 1, wherein the first activation cells have a first output at a rest frequency in the absence of a first input and at an increased frequency dependent at least partially on summed first inputs from the one or more of the sensors.

3. The pattern recognition system of claim 2, wherein the second activation cells have a second output dependent on summed and weighted ones of the first outputs.

4. The pattern recognition system of claim 1, further comprising a plurality of third activation cells arranged in layers including a middle layer and further layers, wherein overlapping subsets of the second activation cells are connected to ones of the third activation cells arranged in the middle layer and overlapping subsets of the third activation cells in the middle layer are connected to ones of the third activation cells arranged in at least one of
the further layers;
wherein the output is adapted to sum at least output one from ones of the third activation cells arranged in the further layers.

5. The pattern recognition system of claim 4, further comprising a feedback between the at least one output of the third activation cells and an input of the second activation cells.

6. The pattern recognition system of claim 1, wherein adjacent ones of the second activation cell are connected so as to change a response of the second activation cell dependent on the output of the adjacent ones of the second activation cell.

7. A method of recognising a pattern comprising:
stimulating the pattern to produce at least one of more sensor inputs at a plurality of sensors;
passing first inputs from an output of ones of the sensors to a plurality of first activation cells;
triggering first outputs from the first activation cells;
passing the first outputs to a subset of second activation cells
triggering second outputs from the subset of the second activation cells
summing the second outputs from a plurality of subsets of the second activation cells; and
deducing a result for the pattern from the summed second outputs.

8. The method of claim 7, further comprising
passing the second outputs to a subsection of third activation cells arranged in a middle layer of a plurality of layers of third activation cells;
triggering at least one of the third activation cells arranged in the middle layer to provide third outputs to ones of the third activation cells arranged in further layers; and
deducing the result from summed and weighted ones of third outputs of the third activation cells.

9. The method of claim 7, wherein outputs of at least one of the third activation cells are fed back to inputs of at least one of the second activation cells.

10. The method of claim 7, wherein the second outputs decay over time.

11. The method of claim 8, wherein a second output of at least one of the second activation cells affects a second output of at least another one of the second activation cells.

12. The method of claim 7, wherein the triggering of the second outputs has a stochastic component.

13. The method of claim 7, wherein the pattern is a medical image.

14. The method of claim 7, further comprising recognising dermatological patterns on a skin of a patient.
